(19) United States
(12) Patent Application Publication
(10) Pub. No.: US 2010/0265958 A1
(43) Pub. Date: Oct. 21, 2010

(54) METHOD FOR EXCHANGING RANGE FORMAT SUPPORT INFORMATION, MEDIA GATEWAY AND MEDIA GATEWAY CONTROLLER

(75) Inventor: Yangbo Lin, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/825,023

(22) Filed: Jun. 28, 2010

Related U.S. Application Data
(63) Continuation of application No. PCT/CN2008/073753, filed on Dec. 26, 2008.

(30) Foreign Application Priority Data
Dec. 28, 2007 (CN) 200710305681.2

(51) Int. Cl. H04L 12/56

(52) U.S. Cl. 370/401

(57) ABSTRACT

A method for exchanging range format support information is provided. The method includes the following steps. A media gateway (MG) receives a command request sent by a media gateway controller (MGC), in which the command request is adapted to deliver range formats requested to be supported by the MG. The MG determines supported range formats according to the range formats requested to be supported by the MG.

### CROSS-REFERENCE TO RELATED APPLICATIONS

This application is a continuation of International Application No. PCT/CN2008/073753, filed on Dec. 26, 2008, which claims priority to Chinese Patent Application No. 200710305681.2, filed on Dec. 28, 2007, both of which are hereby incorporated by reference in their entireties.

### FIELD OF THE TECHNOLOGY

The present invention relates to the communications field, and more particularly to a method for exchanging range format support information, a media gateway (MG), and a media gateway controller (MGC).

### BACKGROUND OF THE INVENTION

A media gateway controller (MGC) and a media gateway (MG) are two key components in the architecture in which service control is separated from service bearing. The MGC is responsible for service control while the MG is responsible for media bearing. Therefore, a service control plane is separated from a media bearing plane. In this way, network resources can be shared fully, equipment upgrading and service expansion can be simplified, and the development and maintenance cost can be reduced.

The widely used communication protocols between the MG and the MGC are the Gateway Control Protocol (GCP) and the Media Gateway Control Protocol (MGCP). The GCP is developed on the basis of the MGCP and usually referred to as H.248/Media Gateway Control Protocol (MeGaCo).

In the H.248 protocol, various resources on the MG are usually abstracted as terminations. Terminations are categorized into physical terminations and ephemeral terminations. The physical terminations represent some physical entities having semi-permanent existence, such as a time division multiplex (TDM) timeslot, and the ephemeral terminations represent some public resources that are applied temporarily and are released after being used, such as a Real-time Transport Protocol (RTP) stream. Further, a special termination called root termination represents the entire MG. The association between terminations is abstracted as a context. A context may include a plurality of terminations. Therefore, a topology is used to describe the association between terminations. A termination that is not associated with another termination is contained in a special context, where the special context is known as a Null context.

Based on the abstract connection model, the service bearer is practically an operation on the terminations and context, which may be accomplished through command requests and command responses between the MGC and the MG. The types of command include Add, Modify, Subtract, Move, Audit Value, Audit Capabilities, Notify, and Service Change. Parameters carried by commands are also referred to as Descriptors, which are categorized into Property, Signal, Event, and Statistic. For the sake of convenience, the parameters that are correlated in services are logically aggregated into a Package.

In addition, the control on the MG by the MGC is usually directed to the terminations or streams on the terminations. Generally, characteristics on the terminations that are not special for streams are carried by a Termination State Descriptor, such as Service State and Event Buffer Control; and characteristics on the terminations that are special for streams are carried by a Media Descriptor, which includes a series of Stream Descriptors. Each Stream Descriptor corresponds to a single stream, so that the Stream Descriptor further includes a Local Control Descriptor, a Local Descriptor, and a Remote Descriptor. The Local Control Descriptor is adapted to carry control information associated with the stream, such as Mode, Reserve Group, and Reserve Value. The Local Descriptor and the Remote Descriptor are adapted to carry features for receiving the stream by the local and remote ends respectively, such as an address, port, and coding/decoding algorithm, in which a Session Description Protocol (SDP) mode is adopted.

In the prior art, a method for controlling media in real time through area information is provided, in which the media is controlled from a certain time point to another time point, from a certain frame to another frame, or from a certain byte to another byte through the range information. For example, a certain media needs to be played from the time point of 3′15″ to 30′45″ or from the 5850^{th} frame to the 55350^{th} frame, or a certain media from the time point of 10′15″ to 30′45″ or from the 18450^{th} frame to the 55350^{th} frame is currently not played yet. Generally, the range information may be expressed in the formats such as a time point, a frame, or a byte, and the time point may be further expressed in the formats such as an absolute time or a relative time.

In the prior art, when the media needs to be controlled in real time through the range information, a user and a media provider are required to learn about range formats supported by each other, thereby generating the demand for exchanging their respective relevant range format support information. Meanwhile, in the architecture that the MGC is separated from the MG, the real-time control on the media is also involved sometimes. Because the user controls the media transfer on the MG through the MGC, if it intends to control the media in real time through the area information, the range formats supported by the user and the MG respectively are required to be exchanged between the MGC and the MG. However, in the prior art, no solution to exchange of range format support information between the MGC and the MG is provided.

### SUMMARY OF THE INVENTION

Accordingly, the present invention is directed to a method for exchanging range format support information, which is applicable to exchange range format support information between an MG and an MGC.

The present invention is directed to an MG, which supports exchange of range format support information.

The present invention is directed to an MGC, which supports exchange of range format support information.

To solve the technical problems, the present invention provides a method for exchanging range format support information, which includes the following steps.

An MG receives a command request sent by an MGC, in which the command request is adapted to request range format supported by the MG. The MG determines supported range formats according to the range formats requested to be supported by the MG.

The present invention provides a method for exchanging range format support information, which includes the following steps.

An MG receives a command request that requests the MG to report supported range format support information, where the command request is sent by an MGC. The MG reports the supported range formats to the MGC according to the command request.

The present invention provides an MG, which includes a first message transceiving unit and a first capability exchanging unit.

The first message transceiving unit is adapted to receive a command request sent by an MGC.

The first capability exchanging unit is adapted to acquire range formats requested to be supported by the MG according to the command request and determine supported range formats.

The present invention further provides an MG, which includes a second message transceiving unit and a second capability exchanging unit.

The second message transceiving unit is adapted to receive a command request sent by an MGC and send a command response to the MGC.

The second capability exchanging unit is adapted to acquire an indication for requesting the MG to report supported range formats from the command request and set the supported range formats in the command response.

The present invention further provides an MGC, which includes a third message transceiving unit and a third capability exchanging unit.

The third message transceiving unit is adapted to send a command request to an MG.

The third capability exchanging unit is adapted to set range formats requested to be supported by the MG in the command request.

The present invention further provides an MGC, which includes a fourth message transceiving unit and a fourth capability exchanging unit.

The fourth message transceiving unit is adapted to send a command request to an MG and receive a command response sent by the MG.

The fourth capability exchanging unit is adapted to set an indication for requesting the MG to report supported range formats in the command request and acquire the supported range formats from the command response.

The foregoing technical solutions have the following advantages or beneficial effects.

1. In the embodiments of the present invention, after the MG receives the command sent by the MGC that carries range formats requested to be supported by the MG, the MG can determine the supported range formats according to the command request, so that the problem that the range formats cannot be exchanged between the MGC and the MG in the prior art is solved.

2. In the embodiments of the present invention, after the MG receives the command sent by the MGC that requests the MG to report the supported range formats, the MG reports the supported range formats to the MGC directly, so that the problem that the range format support information cannot be exchanged between the MGC and the MG in the prior art is solved.

### BRIEF DESCRIPTION OF THE DRAWINGS

FIG. 1 is a flow chart of a method for exchanging range format support information according to Embodiment 1 of the present invention;

FIG. 2 is a schematic view of an MG according to Embodiment 2 of the present invention; and

FIG. 3 is a schematic view of an MGC according to Embodiment 3 of the present invention.

### DETAILED DESCRIPTION OF THE EMBODIMENTS

To enable persons skilled in the art to understand the embodiments of the present invention better, the technical solutions in the embodiments of the present invention are illustrated in the following with reference to the accompanying drawings.

The protocol is extended. The range format support information are indicated by an extended Format Type Property. The property may be defined in an existing package or in a new package. For example, the new package is named a Range Format Indication (rfi) package and the property is named Format Type (ft), which is usually adopted in a format of “rfi/ft”.

It should be noted that, a value of the property may be represented in an enumeration or character string mode. If the enumeration mode is adopted a value range of the property is constant, and an MGC and an MG are implemented easily. However, when the value range intends to be expanded, the original definition needs to be revised. If the character string mode is adopted, the value range of the property is random, so that possible character strings between the MGC and the MG need to be agreed before hand. However, only agreements need to be added when the value range intends to be expanded.

Each value of the property corresponds to one or more area information express formats. The range format support information indicated by the property may be one range information express format or a combination of a plurality of range information express formats.

If the enumeration mode is adopted, a value range of the property includes:

NPT—representing a Normal Play Time format, which is adapted to indicate an absolute position relative to a start time point in terms of time. For example, “npt=1.23-45” indicates from the 1.23^{th} second after the start time point to the 45^{th} second, “npt=6:7:8.9-” indicates from the 8.9^{th} second in the 7^{th} minute in the 6^{th} hour after the start time point to the end, and “npt=now-” indicates from a current time point to the end.

SMPTE—representing a Society of Motion Picture and Television Engineers (SMPTE) format, which indicates a position relative to the start time point in terms of time and is as precise as a frame level, and usually adopts an “hour:minute:second:frame.subframe” format. A corresponding default frame rate is 29.97 frame/second. For example, “smpte=10:20:30:12.3-” indicates 29.97 frame/second and indicates from the 3^{rd} subframe of the 12^{th} frame at the 30^{th} second in the 20^{th} minute in the 10^{th} hour after the start time point to the end.

SMPTE-30—the same as the SMPTE except that the corresponding frame rate is 30 frame/second.

SMPTE-25—the same as the SMPTE except that the corresponding frame rate is 25 frame/second.

UTC—representing a Universal Time Code (UTC) format, which indicates an absolute time denoted according to the Greenwich Mean Time (GMT). For example, “UTC=20001122T010203.45Z” indicates 1:2:3.45 on Nov. 22, 2000, and “UTC=20001122T010203.45Z-” indicates from 1:2:3.45 on Nov. 22, 2000 to the end.

Frame—representing a frame number format, which indicates a position represented by a frame number relative to the start point. For example, “Frame=12345-67890” indicates from the 12345^{th} frame after the start point to the 67890^{th} frame, and “Frame=112233-” indicates from the 112233^{th} frame after the start point to the end.

Byte—representing a byte number format, which indicates a position represented by a byte number relative to the start point. For example, “Byte=10000-90000” indicates from the 10000^{th} byte after the start point to the 90000^{th} byte, and “Byte=50000-” indicates from the 50000^{th} byte after the start point to the end.

Bit—representing a bit number format, which indicates a position represented by a bit number relative to the start point. For example, “Bit=80000-720000” indicates from the 80000^{th} bit after the start point to the 720000^{th} bit, and “Bit=400000-” indicates from the 400000^{th} bit after the start point to the end.

None—representing that no format is correlated.

Alternatively, a value SMPTE-x indicates the formats represented by the above three values, that is, SMPTE, SMPTE-30,and SMPTE-25,at the same time.

If the character string mode is selected, considering the value range of the property, the above different enumeration values may be defined as character strings respectively, for making agreements.

It should be noted that, the property can be applied in terminations or streams on terminations. If the property is applied in the terminations, a Termination State Descriptor may bear the property. If the property is applied in the streams on terminations, a Local Control Descriptor may bear the property. Here, the termination may be a root termination representing the entire MG or an individual termination in the MG.

It should also be noted that, the property is readable and writable, that is to say, the MGC may set the property for the MG to indicate the area information express formats supported by the user, or acquire the property from the MG to obtain the area information express formats supported by the MG.

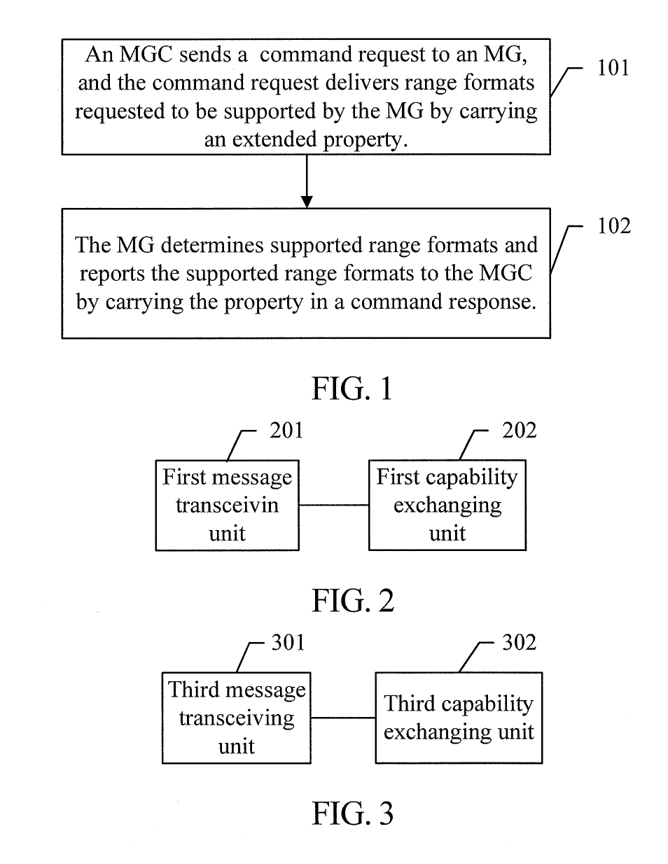

As known from the foregoing illustrations, in the embodiments of the present invention, by extending messages of the existing protocol and carrying the range format support information through the extended property, the interaction between the MG and the MGC is realized. In Embodiment 1, a method for exchanging range format support information is provided, and a flow chart of which is as shown in FIG. 1. The method specifically includes the following steps.

In step 101, an MGC sends a command request to an MG The command request carries an extended property, for example, an rfi/ft property. The MGC delivers range formats requested to be supported by the MG through the property. When the command type of the command request is Add, Modify, Move, or Subtract, the rfi/ft property carried in the command request represents range formats that the MGC requests the MG to support.

Optionally, the MGC delivers range formats that the MGC requests the MG to support through the rfi/ft property and requests the MG to report supported range formats through the rfi/ft property.

In step 102, the MG determines supported range formats according to the command request sent by the MGC, and carries the rfi/ft property in a command response sent to the MGC. The MG reports the supported range formats to the MGC through the property.

It should be noted that, the supported range formats reported to the MGC by the MG may be an intersection between the range formats that the MGC requests the MG to support and the range formats supported by the MG

Optionally, the MG needs to determine the supported range formats according to only the command request sent by the MGC and does not need to report the supported range formats to the MGC.

Optionally, when the command request sent to the MG by the MGC is of Audit Value or Audit Capabilities, the command request expects to obtain the range formats supported by the MG. At this time, the MGC needs to request the MG to report the supported range formats only through the rfi/ft property. In this case, the MG sends a command response to the MGC directly. The command response carries the rfi/ft property, and the MG reports the range formats supported by the MG itself to the MGC through the property.

It should be noted that, when the MGC applies the rfi/ft property for the termination (that is, carried in the Termination State Descriptor), the MG should return range formats supported by the termination. The termination may be a root termination representing the entire MG or an individual termination in the MG.

It should be noted that, when the MGC applies the rfi/ft property for the stream on the termination (that is, carried in the Local Control Descriptor), the MG should return range formats supported by the stream.

It should be noted that, when the MGC needs to apply the rfi/ft property for a certain specific media resource on the termination or stream (the MGC should instruct identification information of the media resource to the MG at the same time), the MG should return range formats supported by the specific media resource on the termination or stream.

Finally, it should be noted that, when the command type of the command request is Add, Modify, Move, or Subtract, the MGC may set a value of the carried rfi/ft property as “select” indicated by a wildcard “$”, representing that the MGC expects to obtain the range formats supported by the MG.

Persons of ordinary skill in the art should understand that all or a part of steps in the methods according to the embodiments may be implemented by a program instructing relevant hardware. The program may be stored in a computer readable storage medium. When the program is executed, the following steps are performed.

An MG receives a command request sent by an MGC. The command request is adapted to deliver range formats requested to be supported by the MG.

The MG determines supported range formats according to the range formats requested to be supported by the MG.

Optionally, when the program is executed, the following steps are performed.

An MG receives a command request for requesting the MG to report supported range formats sent by an MGC.

The MG reports the supported range formats to the MGC according to the command request.

The storage medium may be a read only memory (ROM), a random access memory (RAM), a magnetic disk, or an optical disk.

In Embodiment 2, an MG is provided. Referring to FIG. 2, the MG includes a first message transceiving unit 201 and a first capability exchanging unit 202.

The first message transceiving unit 201 is adapted to receive a command request sent by an MGC and send a command response to the MGC.

The first capability exchanging unit 202 is adapted to acquire range formats requested to be supported by the MG from the command request, and/or acquire an indication for requesting the MG to report supported range formats, determine the supported range formats, and set the supported range formats in the command response.

Optionally, the MG includes a second message transceiving unit and a second capability exchanging unit.

The second message transceiving unit is adapted to receive a command request sent by an MGC and send a command response to the MGC.

The second capability exchanging unit is adapted to acquire an indication for requesting the MG to report supported range formats from the command request and set the supported range formats in the command response.

In Embodiment 3, an MGC is provided. Referring to FIG. 3, the MGC includes a third message transceiving unit 301 and a third capability exchanging unit 302.

The third message transceiving unit 301 is adapted to send a command request to an MG and receive a command response sent by the MG.

The third capability exchanging unit 302 is adapted to set range formats requested to be supported by the MG in the command request, and/or set an indication for requesting the MG to report supported range formats in the command request, and acquire the supported range formats from the command response.

Optionally, the MGC includes a fourth message transceiving unit and a fourth capability exchanging unit.

The fourth message transceiving unit is adapted to send a command request to an MG and receive a command response sent by the MG.

The fourth capability exchanging unit is adapted to set an indication for requesting the MG to report supported range formats in the command request and acquire the supported range formats from the command response.

In conclusion, in the embodiments of the present invention, after the MG receives the command sent by the MGC that carries range formats requested to be supported by the MG, the MG determines supported range formats according to the command request, so that the problem that range formats cannot be exchanged between the MGC and the MG in the prior art is solved.

In addition, in the embodiments of the present invention, after the MG receives the command sent by the MGC that requests the MG to report supported range formats, the MG reports the supported range formats to the MGC directly, so that the problem that the range format support information cannot be exchanged between the MGC and the MG in the prior art is solved.

The method for exchanging range format support information, the MG, and the MGC according to the embodiments of the present invention have been described in detail. The principle and implementation of the present invention are described herein through specific examples. The description about the embodiments of the present invention is merely provided for ease of understanding the method and core ideas of the present invention. Persons of ordinary skill in the art can make changes to the present invention in terms of the specific implementations and application scopes according to the ideas of the present invention. Therefore, the specification shall not be construed as a limit to the present invention.

What is claimed is:

1. A method for exchanging range format support information, comprising:
receiving, by a media gateway (MG), a command request sent by a media gateway controller (MGC),wherein the command request carries range formats the MGC requests the MG to support; and
determining, by the MG, supported range formats according to the command request.

2. The method according to claim 1, wherein the command request carries a property to indicate the range formats requested to be supported by the MG

3. The method according to claim 2, wherein
each value of the property corresponds to one or more range information express formats, and the range formats indicated by the property comprise at least one of the following:
a Normal Play Time (NPT) format;
a Society of Motion Picture and Television Engineers (SMPTE) format adopting a default frame rate;
an SMPTE-30 format adopting a frame rate of 30 frames per second;
an SMPTE-25 format adopting a frame rate of 25 frames per second;
a Universal Time Code (UTC) format;
a frame number (Frame) format;
a byte number (Byte) format;
a bit number (Bit) format; and
no format correlated (None) format; and
the determining, by the MG, the supported range formats according to the range formats requested to be supported by the MG further comprises:
determining, by the MG, the supported range formats according to area information express formats corresponding to the values of the property.

4. The method according to claim 1, wherein the determining, by the MG, the supported range formats according to the range formats requested to be supported by the MG further comprises: determining, by the MG, an intersection between the range formats that the MGC requests the MG to support and range formats supported by the MG.

5. The method according to claim 1, wherein the command request is further adapted to request the MG to report supported range formats, and
the method further comprises:
reporting, by the MG, the determined supported range formats to the MGC.

6. The method according to claim 5, wherein the command request sent by the MGC comprises command requests of Add, Modify, Move, or Subtract.

7. The method according to claim 5, wherein the reporting, by the MG, the determined supported range formats to the MGC further comprises:
sending, by the MG, a command response to the MGC, wherein a property carried in the command response indicates the determined supported range formats.

8. A method for exchanging range format support information, comprising:
receiving, by a media gateway (MG), a command request sent by a media gateway controller (MGC) that requests the MG to report supported range formats; and
reporting, by the MG, the supported range formats to the MGC according to the command request.

9. The method according to claim 8, wherein when the command request is an Audit Value or Audit Capabilities command, the supported range formats that the MG is requested to report are indicated through a carried property.

10. The method according to claim 8, wherein when the command request sent by the MGC is an Add, Modify, Move or Subtract command, the supported range formats that the MG is requested to report are indicated by setting a value of a property carried in the command request to a wildcard representing select.

11. The method according to claim 8, wherein the reporting, by the MG, the supported range formats to the MGC further comprises:
reporting, by the MG, the supported range formats to the MGC through a command response, wherein the command response carries a property to indicate the supported range formats.

12. The method according to claim 11, wherein
each value of the property corresponds to one or more range information express formats, and the range formats indicated by the property comprise at least one of the following:
a Normal Play Time (NPT) format;
a Society of Motion Picture and Television Engineers (SMPTE) format adopting a default frame rate;
an SMPTE-30 format adopting a frame rate of 30 frames per second;
an SMPTE-25 format adopting a frame rate of 25 frames per second;
a Universal Time Code (UTC) format;
a frame number (Frame) format;
a byte number (Byte) format;
a bit number (Bit) format; and
no format correlated (None) format; and
the reporting, by the MG, the supported range formats to the MGC further comprises: reporting, by the MG, a format type (ft) property to the MGC, wherein the supported range formats are indicated through a value of the ft property.

13. A media gateway (MG), comprising:
a first message transceiving unit, adapted to receive a command request sent by a media gateway controller (MGC); and
a first capability exchanging unit, adapted to determine supported range formats according to the command request received by the first message transceiving unit.

14. The MG according to claim 13, wherein
the first capability exchanging unit is further adapted to acquire an indication for requesting the MG to report supported range formats from the command request; and
the first message transceiving unit is further adapted to send a command response to the MGC according to the indication for requesting the MG to report the supported range formats that is acquired by the first capability exchanging unit, and set the supported range formats in the command response.

15. A media gateway (MG), comprising:
a second message transceiving unit, adapted to receive a command request sent by a media gateway controller (MGC) and send a command response to the MGC; and
a second capability exchanging unit, adapted to acquire an indication for requesting the MG to report supported range formats from the command request and set the supported range formats in the command response.

16. A media gateway controller (MGC), comprising:
a third message transceiving unit, adapted to send a command request to a media gateway (MG); and
a third capability exchanging unit, adapted to set range formats requested to be supported by the MG in the command request.

17. The MGC according to claim 16, wherein
the third message transceiving unit is further adapted to receive a command response sent by the MG; and
the third capability exchanging unit is further adapted to set an indication for requesting the MG to report supported range formats in the command request and acquire the supported range formats from the command response.

18. A media gateway controller (MGC), comprising:
a fourth message transceiving unit, adapted to send a command request to a media gateway (MG) and receive a command response sent by the MG; and
a fourth capability exchanging unit, adapted to set an indication for requesting the MG to report supported range formats in the command request and acquire the supported range formats from the command response.
